(19) United States
(12) Patent Application Publication
(10) Pub. No.: US 2026/0365572 A1
(43) Pub. Date: Nov. 19, 2026

(54) RADIATION-SHIELDING COMPOSITE PLASTER PRODUCT

(71) Applicant: ADO Industries Inc., Moundsville, WV (US)

(72) Inventors: Mehmet Gur, Antalya (TR); Cenap Sahabettin Ozben, Istanbul (TR)

(21) Appl. No.: 19/675,997

(22) Filed: May 13, 2026

(30) Foreign Application Priority Data
May 13, 2025 (TR) 2025006061

(51) Int. Cl. C04B 14/36; C04B 28/04; C04B 28/14; C04B 111/00

(52) U.S. Cl. CPC C04B 14/368; C04B 28/04; C04B 28/14; C04B 2111/00568; C04B 2111/00862

(57) ABSTRACT

A composite plaster product includes a dry powder mixture including a Portland type cement, enriched barite, and at least one binding chemical, wherein the enriched barite includes a first fraction of fine barite having a size less than 250 microns and a second fraction of coarse barite having a size greater than 250 microns and less than 710 microns. The first fraction of fine barite provides from 40-60 weight percent (wt %) of the product, the second fraction of coarse barite provides from 8-12 wt % of the product, and the Portland type cement provides from 9-11 wt % of the product. A hardened plaster layer obtained by mixing the dry powder mixture with 20 wt % water and forming a 18 millimeter thick layer of the wet plaster allowed to dry exhibits radiation-shielding efficiency in the 32 keV-1408 keV energy range equivalent to or better than a 2 millimeter thick lead sheet.

### CROSS-REFERENCE TO RELATED APPLICATIONS

The present application claims the benefit of the Turkey patent application 2025/006061 filed on May 13, 2025.

### BACKGROUND

The present disclosure relates to materials for shielding radiation.

### BACKGROUND OF THE RELATED ART

Lead is commonly used within walls, doors, windows, and other structural components of rooms containing X-ray machines or other radiological equipment to attenuate and contain ionizing radiation, such as photons (X or gamma rays) within the designated area. Lead is particularly effective for radiation shielding because of its high density and atomic number, which enable the material to absorb and scatter X-rays and gamma radiation before the radiation can pass through surrounding barriers. However, there are several downsides to the use of lead as a radiation-shielding material. First, lead installation requires multiple materials and steps, increasing labor costs and requiring strict occupational safety compliance. Second, lead also emits secondary radiation, which means that after absorbing incoming gamma radiation lead will emit energy in the form of X-rays. To deal with this secondary radiation, an additional layer of copper or brass is necessary to absorb these secondary rays and avoid background radiation in examination rooms, unnecessary patient dose, and reduced image quality. Still further, lead is a toxic heavy metal known to cause damage over time to the liver, kidneys, joints, and brain tissue and, therefore, requires careful handling, installation and eventual disposal. Due to lead's relatively low melting point, partial fires could vaporize the lead and spread contamination throughout a building.

The conventional method for shielding X-rays and gamma rays is to line the relevant spaces or rooms with lead plates, which are then covered with standard plaster or decorative panels. The thickness of the lead shielding is generally selected based on the type and energy level of the radiation source, expected usage levels, occupancy of adjacent areas, and applicable regulatory safety standards to ensure that radiation exposure outside the room remains below permissible limits. However, some lead sheets used for radiation shielding range from 1.5 millimeter (mm) to 3 millimeters (mm) thick. There is always a risk that micro-particles of lead can detach due to friction and vibration between the lead sheets and the covering materials, potentially causing chronic lead poisoning in personnel working in those rooms or nearby areas. Furthermore, when rooms with lead lining need renovation, the used lead becomes hazardous waste and incurs additional disposal costs.

### BRIEF SUMMARY

Some embodiments provide a dry plaster powder composite material that can be used to form a lead-free radiation-shielding layer that may be applied to the walls of all areas where radiation is used for diagnostic and therapeutic purposes in hospital radiology centers or nuclear medicine centers. The dry plaster powder contains a Portland type cement, dehydrated gypsum (CaSO₄·2H₂O), purified barite (BaSO₄). The dry plaster power is mixed with about 20% water by weight to form a wet plaster (a plaster slurry) that is easy to apply to a surface such as a wall. After applying the wet plaster to about 2 cm to 3 cm thickness to areas enclosed by plasterboard, bordex, pumice, brick, concrete walls, and similar building elements, the wet plaster is allowed to dry into a set or hardened compound in the form of a seamless layer. A 20 millimeter (mm) thick layer (or even an 18 millimeter thick layer) of the hardened compound shields X-rays and gamma rays in the 32-1408 keV energy range with an efficiency equivalent to or better than 2 millimeters (mm) of lead.

### BRIEF DESCRIPTION OF THE SEVERAL VIEWS OF THE DRAWINGS

FIG. 1 is a diagram of a process for producing the radiation-shielding plaster product according to one embodiment.

FIG. 2 is a diagram of a room having walls with a layer of the hardened plaster compound adhered thereto to shield radiation coming from a radiation-emitting device within the room according to one embodiment.

FIG. 3 is a graph comparing shielding efficiency measurements of a 20 millimeter thick layer of the hardened plaster compound and 2 millimeter thick layer of lead in the 32-1408 keV energy range.

### DETAILED DESCRIPTION

Some embodiments provide a dry plaster powder composite material that can be used to form a lead-free radiation-shielding layer that may be applied to the walls of all areas where radiation is used for diagnostic and therapeutic purposes in hospital radiology centers or nuclear medicine centers. The dry plaster powder contains a Portland type cement, dehydrated gypsum (CaSO₄·2H₂O), purified barite (BaSO₄). The dry plaster power is mixed with about 20% water by weight to form a wet plaster (a plaster slurry) that is easy to apply to a surface such as a wall. After applying the wet plaster to about 2 cm to 3 cm thickness to areas enclosed by plasterboard, bordex, pumice, brick, concrete walls, and similar building elements, the wet plaster is allowed to dry into a set or hardened compound in the form of a seamless layer. A 20 millimeter (mm) thick layer (or even an 18 millimeter thick layer) of the hardened compound shields X-rays and gamma rays in the 32-1408 keV energy range with an efficiency equivalent to or better than 2 millimeters (mm) of lead.

Embodiments provide an alternative to lead and all similar products for shielding against radiation in hospital radiology centers, nuclear medicine centers, all areas where radiation is used for diagnostic and therapeutic purposes, X-ray rooms in dental offices, and any facility where radiation is used. A plaster-consistency product may be obtained by mixing the dry plaster powder with 20% water (by weight).

Some embodiments provide a method of producing the dry plaster powder, the wet plaster and/or the hardened compound material. Although the application surface may be interior or exterior walls, the preferred method is generally to apply a layer of the plaster to the interior walls of a room. The radiation dose leaking outside the shielded room, when the radiation source inside is active, is within safe limits for both hospital personnel and patients. Embodiments provide a low-cost, easy-to-apply, lead-free shielding product for hospital radiation rooms that covers the full relevant energy range, produces minimal secondary radiation, and can be manufactured and quality-controlled to consistent standards.

Some embodiments provide a method of using the dry plaster powder to form a radiation-shielding layer. The dry plaster powder is mixed with water to form a wet plaster having a consistency similar to a conventional plaster, also known as drywall mud. The wet plaster may be applied using the same or similar techniques as used to apply conventional plaster. For example, a plastering trowel may be used to apply the plaster in one or more layers, allowing each layer to dry before applying another layer. These layers maybe be applied without any special permits or specialized equipment. Any damage that may occur to the layer during normal use may be repaired by simply reapplying the same plaster to the damaged area. The plaster also has a high ignition temperature and is, therefore, fire resistant.

Embodiments provide a technical benefit over conventional approaches to radiation-shielding by replacing toxic lead with a plaster containing enriched BaSO₄ (specific gravity 4.35-4.45 g/cm³), which is naturally inert and non-toxic. The dry plaster powder forms a paste-like consistency when mixed with 20% water by weight and can be applied to vertical surfaces such as walls at 2 cm to 3 cm thickness. A hardened plaster layer of this material having a thickness of 2 cm (and even 18 millimeters) absorbs X-rays and gamma rays across the 32-1408 keV range with efficiency equivalent to or better than 2 mm of lead. The dry product and the resulting hardened compound is non-toxic and inert and has no adverse effects on human health and offers users a cost advantage. Additionally, because it does not produce secondary radiation, the problems associated with lead use do not arise. In the event of a fire, the plaster layer does not release any hazardous vapor (unlike lead vapor) and does not require any specialized cleanup. Even after demolition, the material is not classified as hazardous waste, incurring no additional disposal costs.

Portland cement is produced from a mixture of limestone and clay that is processed under high heat to form cement clinker. Limestone, which provides calcium carbonate, and clay, which provides silica, alumina, and iron compounds, are mined, crushed, and blended into a substantially uniform raw mixture. The raw mixture is then introduced into a rotary kiln or similar high-temperature furnace where the materials are heated to temperatures of approximately 1,450 degrees Celsius. During heating, the calcium carbonate within the limestone decomposes to form calcium oxide and carbon dioxide, and the calcium oxide chemically reacts with silica, alumina, and iron oxides from the clay to form clinker minerals, including tricalcium silicate and dicalcium silicate. The resulting clinker is cooled before grinding.

The industrial mineral additive includes barite, a polymer, water, and an amine-based chemical. This additive is sprayed into the mixture of clinker and dehydrated gypsum during cement grinding in the pendulum ball vertical mill via nozzles designed to pulverize the minerals in the liquid. The liquid chemical then reacts with the materials being ground (i.e., the clinker and the dehydrated gypsum) during the grinding process, but because the polymer and amine-based chemical act as a catalyst it does not affect the main reaction.

Dehydrated gypsum (calcium sulfate dihydrate (CaSO₄·2H₂O)), also referred to as precipitated gypsum, is obtained and stored after drying. The dehydrated gypsum preferably has a weight percentage of sulfur trioxide (SO₃) that is at least 45%. Dehydrated gypsum has a high whiteness value and positively affects the whiteness of the product.

The surface-adhesion chemical is a polymeric-based chemical. The surface-adhesion chemical is input into a liquid system to react with the clinker during the production of the Portland type cement in the vertical mill.

The cement is a Portland type cement, preferably FORTERACEM cement or equivalent cement. FORTERACEM cement is a low-carbon (low amount of carbon being emitted during production) masonry cement characterized by its production parameters being clearly defined and its limits determined in the TS EN 413-1:2011 standard (a European standard that defines the composition, specifications and conformity criteria for masonry cement for use in mortar for bricklaying, block laying and rendering/plastering). The cement may be obtained by grinding clinker, industrial mineral additives, and dehydrated gypsum. The industrial mineral additive may be sprayed into the cement mixture during grinding. In one option, the industrial mineral additive may be sprayed using a nozzle that is designed to pulverize the minerals. Another feature is that the cement produced thanks to this chemical additive has improved surface adhesion, increased compressive strength, and reduced water requirement compared to other cements. The chemical in question is a pulverized chemical sprayed through nozzles in a pendulum-type vertical mill design.

In some embodiments, the clinker, industrial mineral additives and the dehydrated gypsum may be ground in a pendulum ball vertical mill (often called a pendulum roller mill or suspension roller mill). A pendulum ball vertical mill is an industrial grinding machine designed to pulverize dry, medium-hard materials into fine powder using centrifugal force. It operates vertically, with roller assemblies (pendulums) hanging from a central rotating shaft, which swing outward to crush material against a stationary grinding ring.

The barite that is mixed with the cement to form the plaster product may be extracted by open-pit mining from barite mines, purified by a bleaching process, and separated into fractions as HGS fine barite and HGS coarse barite. The HGS fine barite is characterized by having a 250 micron sieve subsoil content of 10-25% by weight and a specific density ranging from 4.35 g/cm³ to 4.45g/cm³.

Barite ore is first reduced to sizes of 2-5 mm. Then, the crushed barite is washed with hydrochloric acid and sulfuric acid in a bleaching process. The barite may also be enriched to a higher barite concentration by treating the barite with heat at a temperature from 1300 to 1370 °C in a rotary kiln for about 35 minutes. The bleached and enriched barite (purified barite) is dried and stored. _ Purified barite (BaSO₄) is obtained from by enriching raw barite having a low percentage of barium oxide (BaO) and a low percentage of sulfur trioxide (SO₃) using a bleaching process. The concentration of barite (BaSO₄) is increased from about 88 weight percent (wt %) to at least 91 weight percent barite and preferably at least 93 weight percent barite.

The fine grain purified barite (BaSO₄) may have a grain size ranging from 150 to 300 microns, preferably less than or equal to about 250 microns. For example, the fine grain purified barite should pass through a 250 micron sieve. The coarse grain purified barite (BaSO₄) may have a grain size ranging from 360 to 800 microns, preferably less than or equal to about 710 microns but greater than 250 microns. For example, the coarse grain purified barite should pass through a 710 micron sieve but should not pass through a 250 micron sieve. The fine and coarse grain purified barite (BaSO₄) both have a specific gravity of 4.35-4.45 g/cm³.

In some embodiments, the binding chemicals are amine-based. The binding chemicals are added into the mixer to be mixed with the barite and the cement. Binding chemicals are added as additives in the product's formation. The binding chemicals may further include hydroxypropyl methylcellulose (HPMC), polymers, and chemicals with viscosity-increasing and film-forming properties.

A dry plaster powder is formed by mixing the cement, purified barite, and binding chemicals. For example, these components may be fed into a mixer via micro-dosing equipment. The components are preferably mixed for about 90 seconds. The mixing preferably occurs at a humidity of about 0.5 percent and ambient temperature. The dry mix may further include cellulose, starch, and/or an air-entraining chemical agent such as an anionic surfactant. All are powdered chemicals.

The purified barite may include a combination of HGS fine barite and HGS coarse barite. Optionally, an XCT barite may also include included. XCT barite is a derivative of HGS barite having a density of 4.32-4.35 g/cm³ after enrichment and is obtained by flotation. Accordingly, the density of the XCT barite (ranging from 4.32-4.35 g/cm³) is slightly less than the density of the HGS fine and coarse barite (ranging from 4.35 g/cm³ to 4.45g/cm³).

In some embodiments of the composite plaster product, the first fraction of fine barite comprises from 40 to 60 weight percent of the composite plaster product, the second fraction of coarse barite comprises from 8 to 12 weight percent of the composite plaster product, and the Portland type cement comprises from 9 to 11 weight percent of the composite plaster product. Most preferably, the first fraction of fine barite comprises about 50 weight percent of the composite plaster product, the second fraction of coarse barite comprises about 10 weight percent of the composite plaster product, and the Portland type cement comprises about 10 weight percent of the composite plaster product.

In some embodiments, the composite plaster product may include from 5 to 7 weight percent dehydrated gypsum, and most preferably about 6 weight percent. Still further, the composite plaster product may include from 0.8 to 2.5 weight percent of the surface-adhesion chemicals, and most preferably about 1 weight percent.

In some embodiments, the wet plaster (slurry) is formed by mixing the dry plaster with about 20 weight percent water. For example, about 8 pounds of the dry plaster may be mixed with about 2 pounds of water using a basic drill with a paddle secured to the drill. Using too little water may make the wet plaster too viscous, thereby making the wet plaster difficult to process and apply. Using too much water may make the wet plaster too runny and difficult to process and apply. Water may be added to achieve a desired consistency. In one option, the wet plaster may be manually applied to a wall or other surface using a trowel. For example, the wet plaster may be applied in several layers, where each layer is allowed to dry and harden before applying the next layer. Additional layers may be applied until the desired thickness is achieved.

The hardened compound plaster layer preferably has a thickness between about 0.75 inches (18 millimeters) and about 1.0 inches (25 millimeters) for a radiology room, such as a computed tomography (CT) and/or X-ray room in a medical scanning facility. The most preferred thickness of the hardened compound plaster layer is about 0.8 inches (20 millimeters), which provides as much or more radiation shielding as 2 mm of lead without using an excessive amount of the product. A CT scanner combines X-ray equipment with advanced computers to create detailed, cross-sectional images of internal organs, bones and soft tissue of a person.

In some embodiments, the hardened compound plaster layer may be combined with other construction materials, treatments and/or layers to form a finished wall system. In one option, the finish wall system may include multiple layers applied to a clean, stable substrate such as brick, concrete, bordex, pumice, drywall (plasterboard) or a modular system. For example, the multiple layers may include (1) primer, (2) bonding mortar, (3) hardened compound plaster as described herein, (4) satin plaster (finish coat), and (5) antibacterial paint applied in sequence over the substrate. The use of a “primer” layer is helpful to reduce surface absorbency and form bonds. The hardened compound plaster according to various embodiments, provides a radiation-shielding barrier that prevents the X-rays and/or gamma rays from passing through the barrier. The satin plaster (finish coat) layer provides a protective layer to prevent damage to the hardened compound plaster. The antibacterial paint layer may be optionally applied for both improved aesthetics and hygiene. The hardened compound plaster is fire resistant with an ignition temperature above 1500 °C. Barite is an inert material that does not exhibit toxicity like lead.

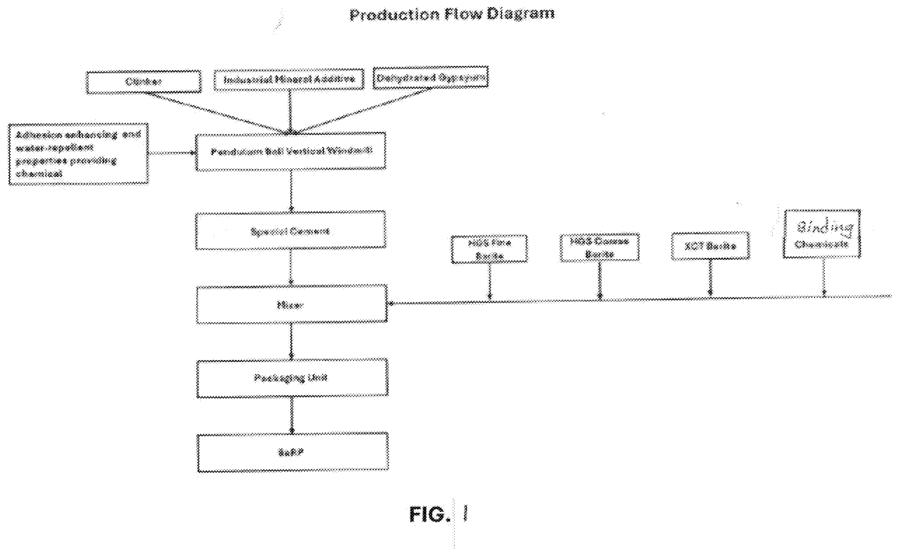

FIG. 1 is a diagram of a process for producing the radiation-shielding plaster product according to one embodiment. Clinker, industrial mineral additives, dehydrate gypsum and a chemical with adhesion enhancing and water-repellent properties are combined in a pendulum ball vertical windmill to produce a cement (“special cement”). The dry powder cement is then combined in a mixer with the other dry ingredients including HGS fine barite, HGS coarse barite, XCT barite and binding chemicals. The resulting mixture is then packaged in a packaging unit and is ready for distribution (as BaRP). An end user may then add water and apply to a surface such as a wall to form a seamless radiation-shielding hardened plaster layer.

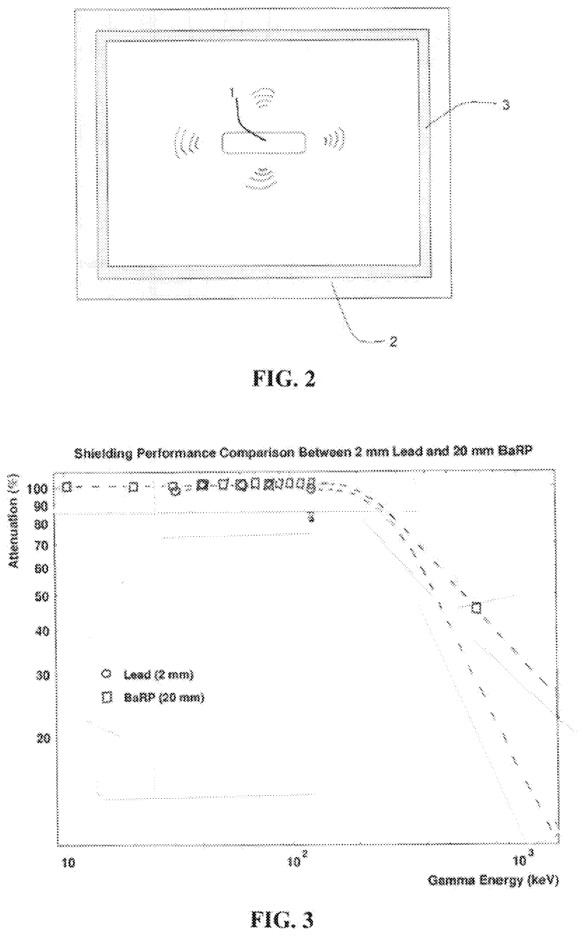

FIG. 2 is a diagram of a room having walls (2) with a layer of the hardened plaster compound (3) adhered thereto to shield radiation coming from a radiation-emitting device (1) within the room according to one embodiment. Non-limiting examples of the radiation-emitting device include an X-ray machine of computed tomography (CT) scanner.

FIG. 3 is a graph comparing shielding efficiency measurements of a 20 millimeter thick layer of the hardened plaster compound (aka BaRP) and 2 millimeter thick layer of lead in the 32-1408 keV energy range. The horizontal axis is the level of gamma energy (keV) directed at a specimen and the vertical axis is the measured level of attenuation (%) of the specimen. Measurements of the 2 cm thick hardened plaster product layer are shown using squares and measurements of the 2 mm thick lead sheet are shown using circles.

The radiation permeability tests were performed on specimens obtained by mixing the dry plaster with 20 weight percent water, casting the wet plaster in molds at 2 cm thickness, and allowing hardened compound to set in water for a minimum of 2 and a maximum of 28 days prior to radiation testing in conformance with the curing test method set out in the TS EN 197-1/2 standard. Radiation permeability or shielding tests were performed in the 32 keV- 1408 keV energy range characterized by gamma rays emitted from a source, where the gamma rays were collimated to prevent scattering during measurements. Measurements of the radiation were taken using a 20%-efficient Nal(Tl) detector and its associated nuclear counting system. All radiation permeability measurements on the plaster specimen and lead were conducted in the same counting and source geometry so as to preclude systematic errors. Accordingly, the test measurements in the stated energy range showed that the shielding efficiency of the present product at 20 millimeters (mm) thickness is equivalent to or better than 2 millimeters (mm) of lead.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

1. A composite plaster product, comprising:
a dry powder mixture including a Portland type cement, enriched barite, and one or more binding chemicals, wherein the enriched barite includes a first fraction of fine barite having a size less than 250 microns and a second fraction of coarse barite having a size greater than 250 microns and less than 710 microns.

2. The composite plaster product of claim 1, wherein the first fraction of fine barite comprises from 40 to 60 weight percent of the composite plaster product, and wherein the second fraction of coarse barite comprises from 8 to 12 weight percent of the composite plaster product.

3. The composite plaster product of claim 2, wherein the Portland type cement comprises from 9 to 11 weight percent of the composite plaster product.

4. The composite plaster product of claim 3, wherein a hardened plaster layer obtained by mixing the dry powder mixture with 20 weight percent water to form a wet plaster and forming a 20 millimeter thick layer of the wet plaster that is allowed to dry is characterized by a radiation-shielding efficiency of radiation in the 32 keV- 1408 keV energy range that is equivalent to or better than that of a 2 millimeter thick lead sheet.

5. The composite plaster product of claim 4, wherein the radiation includes X-rays and/or gamma rays.

6. The composite plaster product of claim 4, wherein the first fraction of fine barite comprises about 50 weight percent of the composite plaster product, and wherein the second fraction of coarse barite comprises about 10 weight percent of the composite plaster product.

7. The composite plaster product of claim 6, wherein the Portland type cement comprises about 10 weight percent of the composite plaster product.

8. The composite plaster product of claim 3, wherein the enriched barite has a barite concentration of at least 91 weight percent and a specific gravity ranging from 4.35 to 4.45g/cm³.

9. The composite plaster product of claim 2, wherein the barite further includes a third fraction of XCT barite.

10. The composite plaster product of claim 1, wherein the Portland type cement is a composition including an industrial mineral additive, dehydrated gypsum, and clinker that have been ground into a dry powder in a pendulum ball vertical mill, and wherein the clinker is produced from a mixture of limestone and clay.

11. The composite plaster product of claim 10, wherein the industrial mineral additive is sprayed into the dehydrated gypsum and clinker during grinding within the pendulum ball vertical mill.

12. The composite plaster product of claim 11, wherein the industrial mineral additive includes barite.

13. The composite plaster product of claim 1, wherein the one or more binding chemicals include hydroxypropyl methylcellulose, polymers and/or chemicals with viscosity-increasing and film-forming properties.

14. A method, comprising:
adding 20 weight percent water to the composite plaster product of claim 1 to form a wet plaster;
applying the wet plaster to over a stable substrate surface to form a seamless layer; and
allowing the wet plaster to dry into a seamless hardened composite plaster layer, wherein the hardened composite plaster layer has a thickness between about 18 millimeters and about 25 millimeters.

15. The method of claim 14, wherein the wet plaster is applied to the surface in a sequence of multiple layers, and wherein each layer of wet plaster is allowed to dry before applying another layer of wet plaster in the sequence of multiple layers.

16. The method of claim 14, wherein the surface is a wall of a room including radiation-emitting equipment.

17. The method of claim 14, wherein the hardened composite plaster layer has a thickness of at least 20 millimeters and is characterized by a radiation-shielding efficiency of radiation in the 32 keV- 1408 keV energy range that is equivalent to or better than that of a 2 millimeter thick lead sheet.

18. The method of claim 14, further comprising:
applying a primer layer and a bonding mortar layer to the stable substrate surface prior to applying the wet plaster; and
applying a finish plaster layer and paint over the hardened composite plaster layer.

19. The method of claim 14, further comprising:
bleaching the barite with hydrochloric acid and sulfuric acid; and
forming the enriched barite by heating the barite at a temperature from 1300 to 1370 °C in a rotary kiln for about 35 minutes to reach a barite concentration of at least 91 weight percent in the enriched barite.

20. The method of claim 14. wherein the stable substrate includes brick, concrete, bordex, pumice, and/or drywall.
